(19) United States
(12) Patent Application Publication
(10) Pub. No.: US 2003/0134545 A1
(43) Pub. Date: Jul. 17, 2003

(54) Biomedical electrodes and biomedical electrodes for electrostimulation

(76) Inventors: Eric Thomas McAdams, County Antrim (IE); Philip Andrew, Berkshire (GB)

Correspondence Address: Klein & Szekeres, 4199 Campus Drive Suite 700, Irvine, CA, 92612, US

(21) Appl. No.: 10/111,369

(22) PCT Filed: Aug. 23, 2001
(86) PCT No.: PCT/IB01/01520

(30) Foreign Application Priority Data
Aug. 24, 2000 (GB) 0020936.1
Oct. 13, 2000 (IE) S2000/0829

(51) Int. Cl. H01R 13/73

(52) U.S. Cl. 439/909

(57) ABSTRACT

The present invention is based on our surprising finding that, by selection of the appropriate sheet resistance of the current distribution member in conjunction with a suitably low impedance at the interface between the current distribution member (2) and the adhesive substrate (4), the incidence of peripheral hot spots and edge effects associated with high current density can be substantially reduced.

The present invention relates to biomedical electrodes, and more particularly to electrodes for establishing electrical connection to a patient's skin.

Biomedical electrodes generally comprise a backing member (typically in sheet form), an electrically conductive gel layer (typically an adhesive, skin compatible, flexible, hydrogel layer) provided between the backing member and the patient's skin, and an electrical terminal arrangement in electrical contact with the gel layer and adapted for connection to an electrical lead or apparatus. The electrode may, but need not, include a current distribution member between, and in electrical contact with, the gel layer and the electrical terminal arrangement, which in use assists in distributing the electrical current to as wide an area of the gel layer as possible. Where a current distribution member is present, and extends over only a portion of the sheet backing member to leave an outer periphery of the backing member over which the current distribution member does not extend, the conductive gel layer may optionally extend only over the current distribution member, with a different adhesive being used to render the outer periphery of the sheet backing member skin-adhesive.

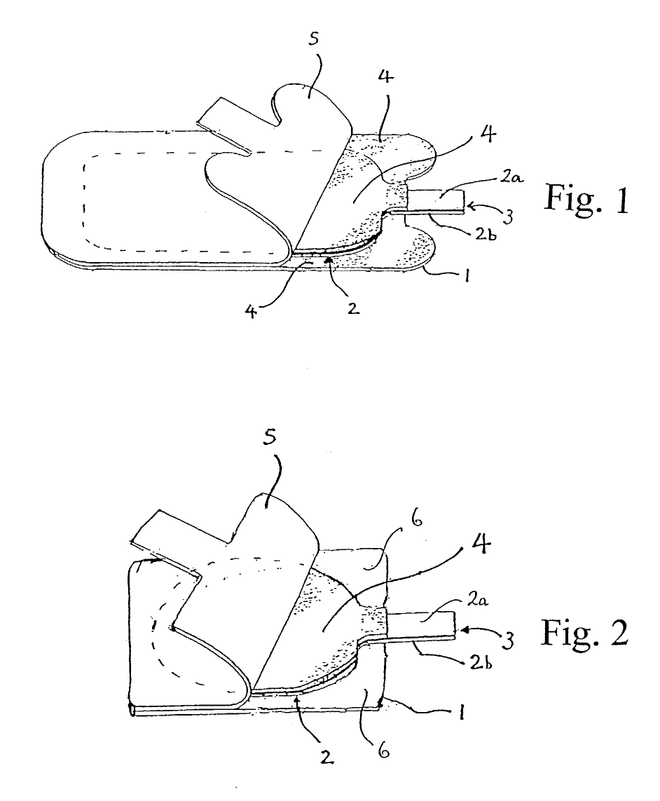

FIG. 1 of the accompanying drawings shows one known design of biomedical electrode, marketed under the name NEUTRALECT (TM) (MSB Limited, Ramsbury, UK, tel +44 1672 522 100).

This prior art electrode is used as an electrosurgical dispersive electrode, and is typically affixed to the patient's skin during electrosurgery to enable an electrical circuit to be completed through the patient's body. The electrode is quite large, over 1 Scm in length. As shown in the drawing, an electrically insulative backing member 1 is provided, in the form of a layer of a synthetic foam, on which an electrically conductive current distribution member 2, in the form of a bilayer sheet including a metal (e.g. aluminium) foil 2a and a synthetic (e.g. polyester) support layer 2b, is overlain as a current distribution member. The general configuration of the current distribution member is shown in dotted lines in FIG. 1. The layer represented by the foil 2a is shown in black in the side-on portions in FIG. 1. The insulative backing member 1 extends beyond the periphery of the current distribution member, to provide secure adhesion of the electrode to the skin, even in the presence of fluids, and to reduce the risk of a member of the operating team accidentally touching the foil layer 2a when it is live. The electrical temminal arrangement comprises a tab formation 3, being an extension of, and integral with, the current distribution member 2, which tab fommation is adapted to be gripped by electrically conductive jaws of a crocodile clip or the like (not shown), connected to an electrical lead (not shown).

Still with reference to FIG. 1, the assembly includes an electrically conductive adhesive hydrogel layer 4, which extends over the backing member and the current distribution member on the skin-directed face of the electrode, and in use adheres to the patient's skin and provides electrical connection between the patient's skin and the current distribution member 2. The tab fommation 3 is not covered by this gel layer 4.

The gel layer 4 is protected before use by a release layer 5 of siliconised paper or the like, which as shown is simply peeled off before use.

Electrodes of the general arrangement shown in FIG. 1, and variant fomms thereof, are widely used in modem clinical and surgical practice. Such electrodes may be generally categorised as power coupling electrodes, i.e. electrodes that cause electrical power to pass through the patient's body. Power coupling electrodes are used in the active stimulation of muscular contraction and relaxation, and may take the fomm, for example, of electrostimulation devices such as TENS electrodes for pain management; EMS (neuromuscular stimulation) electrodes for treating conditions such as scoliosis; external cardiac pacing electrodes for delivering electrical impulses (at a current of up to about 200 amps) to a patient's heart from an external cardiac pacemaker; defibrillation electrodes to dispense electrical impulses (at a current of up to about 50 milliamps) to a chest cavity of a mammalian patient to defibrillate the patient's heart; and dispersive electrodes to complete the electrical circuit for the applied electrical signal/impulse (at a current of between about 0.25 and 1 amp and a voltage of hundreds or thousands of volts) dispensed into a patient during electrosurgery, e.g. in a diathemmy or cauterisation procedure.

Electrodes are also known, which are designed for passing much smaller amounts of electrical power. These are generally categorised as monitoring electrodes. Monitoring electrodes are used in the monitoring and diagnosis of medical conditions by passive transmission of biological orphysiological electrical potential (normally associated with muscle or nerve activity) via the electrode to external monitoring apparatus. Such electrodes may take the foml, for example, of diagnostic devices such as ECG (electrocardiogram) electrodes for monitoring heart activity and for diagnosing heart abnormalities.

A general problem with known power coupling electrodes lies in the unpredictable occurrence of electrical current “hot spots”, i.e. points of high current density across the skin-contacting surface of the gel layer. These hot spots can cause burns and considerable pain, discomfort and for trauma to the patient and are obviously undesirable. In severe cases, the amount of current used may have to be reduced during a surgical or clinical procedure, which may impair the effectiveness of the treatment, therapy or procedure.

Current density hot spots typically occur under the perimeter of an electrode. Wiley and Webster (“Analysis and Control of the Current Distribution under Circular Dispersive Electrodes”, IEEE Trans. Biomed. Eng., Vol BME-29, pp. 381-385, 1982) showed that current flow through a circular electrode placed on a semi-infinite medium could be solved analytically. They found that for an electrode of radius a and total current lo into the electrode, the current density into the body as a function of radial distance from the centre r was given by:

$$J ( r , o ) = \frac{Jo}{2 * {[ 1 - {( r / a )}^{2} ]}^{1 / 2}} , ( A \text{/} {cm}^{2} ) \qquad r \leq a$$

where Jo=lo/pa², i.e. a hypothetical uniform current density.

For the idealised case of an infinitely sharp boundary between a perfectly circular electrode, an infinitely thin disk and a semi-infinite medium, the vertical current density approaches infinity at the perimeter (r=a).

Under normal circumstances, however, one finds a sharp rise to a finite maximum due to various physical and modelling characteristics of the electrodes, the patient's body and the interface between the two. This finite maximum is manifested as the peripheral hot spots.

The above equation shows that the middle portion of the electrode is relatively ineffective in carrying the current, because half the total current flows through an annular perimeter of r>0.86a, i.e. through an annulus 0.14a wide or one seventh of the radius.

In IEEE Trans. Biomed. Eng., Vol. BME-33, pp. 845-853 (1986) (the disclosure of which is incorporated herein by reference), Kim et al proposed two alternative electrode designs to reduce the incidence of peripheral hot spots. One proposal was a simple plate electrode with a uniformly high resistivity hydrogel layer and an intermediate width current distribution member, for use in low-energy applications such as external cardiac pacing. The second proposal was an annular electrode in which the resistivity of the hydrogel layer varies as a function of radial distance from the centre, for use both in low-energy and also in high-energy applications such as electrosurgery and defibrillation.

U.S. Pat. No. 4,736,752 (Munck et al, 1988) (the disclosure in which is incorporated herein by reference) describes a power coupling electrode in which a current distribution member formed by a layer of a conductive ink on an insulative backing layer is provided with a regular and predetermined array of voids (non-conductive areas) arranged over its surface area. The arrangement is said to control the extent of peripheral hot spots.

U.S. Pat. No.5,836,942 (Netherly et al, 1998) (the disclosure of which is incorporated herein by reference) describes a power coupling electrode in which a generally annular field of “lossy dielectric” material is applied to the periphery of the current distribution member and the whole is overlain with the hydrogel layer. The arrangement is stated to reduce the extent of peripheral hot spots. The lossy dielectric material is stated to be screen printed or sprayed in liquid form, e.g. as an enamel or ink, to provide the generally annular field of material at the proper time during fabrication of the electrode. The lossy dielectric material is applied in a non-uniform manner, resulting in an electrical impedance gradient ranging from about 30% to about 90% of maximum impedance as one goes from the centre of the electrode towards the periphery.

None of the above proposals is entirely satisfactory. The manufacture of non-uniform layers is troublesome and leads to additional costs and wastage in the electrode manufacturing process. Moreover, creating substantial areas of preferentially low impedance in the non-peripheral region of an electrode runs the risk of causing a high current density if the electrode becomes partially lifted or dislodged with current flowing, or if the electrode is not applied properly initially. The proposals known in the art are not applicable universally to low-current as well as high-current electrodes, but tend to be specific proposals for specific types of electrodes.

It is an object of the present invention to go at least some way towards solving the problem set out above, or at least to provide an acceptable alternative biomedical electrode.

The present invention is based on our surprising finding that, by selection of the appropriate sheet resistance of the current distribution member in conjunction with a suitably low impedance at the interface between the current distribution member and the gel layer, the incidence of peripheral hot spots and edge effects associated with high current density can be reduced. Moreover, we have found that this advantage is applicable both to power coupling electrodes and to diagnostic electrodes.

According to the present invention, there is provided a biomedical electrode adapted to contact in use an area of a patient's skin to conduct electrical current thereto or therefrom, the electrode comprising:

(i) a backing member;

(ii) an electrically conductive gel layer for contacting the patient's skin;

(iii) an electrical terminal arrangement adapted for connection to an electrical lead or apparatus; and

(iv) a current distribution member, comprising a relatively thin, electrically conductive layer, the current distribution member contacting the gel layer via an interface between the conductive layer of the current distribution member and the gel layer and providing an electrical connection between the gel layer and the electrical terminal arrangement, the conductive layer of the current distribution member having an electrical sheet resistance and the interface between the conductive layer of the current distribution member and the gel layer having an electrical impedance;

wherein the electrical sheet resistance of the conductive layer of the current distribution member and the electrical impedance of the interface between the conductive layer of the current distribution member and the gel layer are selected to substantially avoid the occurrence of undesirable peripheral hot spots or edge effects when the electrode is in use.

The expression “street resistance”, used herein, refers to the conventional measure of the electrical resistance of a relatively thin electrically conductive layer to a current flowing in the direction of the plane of the layer. The sheet resistance, Rs, of a layer is suitably measured by a 4-point probe. A geometric correction factor (k) is required to convert the voltage(V)/current(I) ratio (=R) measured by the 4-point probe into sheet resistance, i.e. Rs=(V/I)k=Rk. The correction factor accounts for sample size, shape and the spacing between the probes. Strictly speaking, the unit of sheet resistance is the ohm. However, to avoid confusion between R and Rs, sheet resistance is conventionally specified in units of Ω/□ (ohms per square, i.e. the ohms per unit square (of any size) of the thin layer). The term “relatively thin”, used in relation to the electrically conductive layer portion of the current distribution member, which gives rise to the property of sheet resistance in the current distribution member, generally means that the layer thickness dimension is substantially smaller than the dimension across the face of the layer, and in particular refers to a layer of sufficient thinness relative to its area that the property of sheet resistance as defined above is relevant.

The sheet resistance of the conductive layer of the current distribution member will suitably be in the range of about 0.01 to about 50 ohms/□, more preferably about 0.1 to about 0.5 ohms/□. This is suitably measured using a 4-point probe available from Fell Resistivity Equipment, MinirosinLimited, England, coupled to a current source, —for example a Thurlby current source, and a multimeter (e.g. an RS Components 8010A digital multimeter).

The sheet resistance of the conductive layer of the current distribution member may vary across its area, at a micro or macro level, or both. Variations in sheet resistance at micro level may, for example, occur through microscopic variations in the thickness of the layer, for example due to surface roughness (if the surface roughness is significant in proportion to the continuum thickness of the layer, this can vary the sheet resistance).

The electrical impedance of the interface between the conductive layer of the current distribution member and the gel layer is preferably maintained as low as possible, and the figures given above for the preferred sheet resistance of the conductive layer of the current distribution member are provided on this basis. If the electrical impedance of the interface would be higher, the sheet resistance of the conductive layer of the current distribution member should be adjusted to compensate.

We have found that at least one point of balance can be observed between the interface impedance and the sheet resistance, at which the incidence of undesirable peripheral hot spots and edge effects are dramatically reduced in comparison with corresponding electrodes having different interface impedance and/or sheet resistance. The present invention is based upon the appreciation of this effect, and the control of the parameters when electrodes are constructed. Without wishing to be bound by theory, it is believed that, at the critical balance point, the path of least resistance for electrical current flow is not merely the path towards the edges of the current distribution member, but is an optimal combination of such apath and also the path into the gel layer over the interface between the current distribution member and the gel layer.

The surface topography of the interface, as well as the composition of the gel layer and the current distribution member, can affect the interface impedance, in addition—as mentioned above—to the sheet resistance of the conductive layer of the current distribution member. These factors can be used to control the optimum balance between the sheet resistance and the interface impedance, to minimise the occurrence of hot spots and edge effects, according to the invention.

The invention enables the parts (ii) and (iv) to be fabricated as substantially uninterrupted layers interfacing across substantially the entire electrically conductive area of the electrode. According to a preferred feature of the present invention, the parts (ii) and (iv) are provided as substantially uninterrupted layers extending across substantially the entire electrically conductive area of the electrode. This leads to considerable manufacturing cost advantages.

If desired, the electrically conductive area of the electrode can be divided into two or more fields, by means of a number of current distribution members provided on the backing layer, each separated from its neighbour by a gap across which no or little current can flow. The use of such “split” electrode designs (in which, typically, two electrically conductive fields are separated by a gap (“split”) along the central line of the electrode) is known for conventional electrodes, and is equally applicable to the novel electrodes of the present invention. The use of “split” electrodes is found in appropriate cases to further reduce the incidence of undesirable peripheral hot spots and edge effects, compared with corresponding electrodes in which the conductive field is not split.

Most preferably, the electrode consists essentially of parts (i) to (iv). As supplied for use, the electrode will normally include also a protective release sheet, for example a sheet of plastic or coated plastic (e.g. siliconised plastic) or paper or coated paper (e.g. siliconised paper), which protects the gel layer (ii) and is peeled off immediately before use.

It is found that, using the electrode of the present invention, the current density at the peripheral portion of the current-passing area of the electrode is generally not substantially greater than the current density found in the non-peripheral portion, despite the fact that the current distribution member is preferably substantially void free. Therefore, in many cases the deleterious effects of peripheral hot spots or edge effects is reduced or eliminated.

Backing Member

The backing member (i) typically comprises a sheet having first and second major surfaces, configured and dimensioned according to the function the electrode has to perform.

The backing member is preferably electrically insulative, flexible and conformable to the skin contours of the patient.

The backing member may, for example, comprise a sheet made from an electrically insulative plastics material such as a polyester, a polycarbonate or a nylon. A foamed plastics material may also be used. The backing member may be unitary or may be composed of more than one layer.

The backing member may have a flat surface configuration at the surface directed towards the current distribution member, or may alternatively have an irregular surface topography mirroring the desired configuration of the interface between gel layer and the conductive layer of the current distribution member.

For further details of materials, configurations and fabrication methods relating to the backing member which may be used in the present invention, attention is directed, for example, to the following publications: U.S. Pat. Nos. 4,524,087; 4,539,996; 4,715,382; 4,771,713; 4,846,185; 4,848,353; 5,012,810; 5,133,356; 5,779,632; and 5,853,750; all the disclosures of which are incorporated herein by reference.

Electrically Conductive Gel Layer

The electrically conductive gel layer (ii) is preferably an adhesive, dimensionally stable, flexible natural or synthetic hydrogel, conformable to the skin contours of the patient.

Synthetic hydrogels are preferred, and most preferred are the polymerisation reaction products of one or more unsaturated free radically polymerisable monomer capable of polymerisation to a hydrophilic polymer. The monomer may be ionic or non-ionic or a mixture thereof.

By carrying out the polymerisation in water, the hydrophilic polymer is desirably formed with a certain amount of water trapped in the polymeric matrix. Alternatively or additionally, the polymer will imbibe water after formation of the polymeric matrix.

The polymer may desirably be cross-linked to improve the dimensional stability and performance. To achieve cross-linking, one or more cross-linking agent comprising a multifunctional unsaturated free radically polymerisable compound is preferably included in the polymerisation reaction mixture.

The gel must be electrically conductive. This may be achieved by including an electrolyte (e.g. a salt) in the aqueous phase. A suitable salt will usually be an alkali metal halide such as sodium chloride or potassium chloride. However, any compound capable of donating ions to the system may be used, for example lithium chloride, calcium chloride or ammonium chloride. The amount of electrolyte that should be present in the adhesive substrate is dependent on the electrical properties required. Where the gel is the polymerisation reaction product of at least one ionic monomer, it may be inherently electrically conductive, in which case the addition of a separate electrolyte to the aqueous phase may be unnecessary.

The gel is present in the electrode as a layer having first and second major faces, one of which interfaces with the current distribution member (iv). The thickness of the gel layer can be chosen by one of ordinary skill in this art, according to the particular desired electrode characteristics. Generally speaking, however, the layer will typically have a continuum thickness (i.e. disregarding any irregularity at the interface with the current distribution member) in the range of about 100 to about 5000 μm, more preferably about 500 to about 1500 μm. This thickness can conveniently be measured by light microscopy.

For further details of the ingredients, compositions end preparative methods relating to a range of possible electrically conductive synthetic hydrogels which may be used in the present invention, attention is directed, for example, to the following publications: WO-A-97/05171; WO-A-97/24149; WO-A-98/19311; WO-A-00/06214; WO-A00106215; WO-A-00/07638; end U.S. Pat. No.4,848,353; all the disclosures of which are incorporated herein by reference.

Electrical Terminal Arrangement

The electrical terminal arrangement (iii) may comprise any convenient conductor member for establishing an electrical connection between an electrical lead or apparatus and the current distribution member (iv).

In one preferred embodiment, the electrical terminal arrangement can comprise an electrically conductive tab extending from the periphery of the electrode, for example as shown generally in FIG. 1, the tab being in electrical contact with the current distribution member (iv). In the case of a “split” electrode design, a number of electrical connections will be provided, each connecting between the tab and its respective current distribution member.

In another possible embodiment, the electrical terminal arrangement can comprise an electrically conductive lead wire, one end of which is in electrical contact with the current distribution member and the other end of which extends from the electrode for connection to an electrical apparatus.

Still further, the electrical terminal arrangement can alternatively comprise an eyelet or other snap-type connector.

For further details of the configurations and designs relating to a range of possible electrical terminal arrangements which may be used in the present invention, attention is directed, for example, to the following publications: U.S. Pat. Nos. 4,527,087; 4,539,996; 4,554,924; 4,715,382; 4,771,713; 4,846,185; 4,848,353; 5,012,810; 5,133,356; and 5,853,750; all the disclosures of which are incorporated herein by reference.

Current Distribution Member

The current distribution member (iv) comprises a relatively thin electrically conductive layer, which may, for example, comprise a conductive sheet or foil, e.g. of metal or of a composite including conductive particles embedded in a conductive matrix, or may alternatively comprise the dry residue of an electrically conductive ink, such as, for example, a conductive silver-containing printing ink.

The current distribution member may conveniently include a support substrate, e.g. a support layer, for the relatively thin electrically conductive layer, to provide mechanical strength and integrity. The support substrate is preferably electrically non-conductive. The current distribution member is preferably flexible and conformable to the skin contours of the patient. For this purpose, a synthetic sheet such as a polyester may be used as the support substrate. The synthetic sheet may suitably have a thickness in the range of about 50 to about 250 μm.

The conductive layer of the current distribution member generally has a layer thickness less than, preferably substantially less than, the thickness of the gel layer. The main factor in determining the precise thickness of the conductive layer of the current distribution member is the selection of the desired conductance/resistance of the current distribution member. The sheet resistance of the conductive layer of the current distribution member is preferably within the range of about 0.01 to about 50 ohms/□, more preferably about 0.1 to about 0.5 ohms/□, as measured by a four-point probe (Fell Resistivity Equipment, Minirosin Ltd. England) coupled to, for example, a Thurlby current source and an RS Components 8010A Digital Multimeter.

In one example of the invention, the conductive layer of the current distribution member may be formed by the deposition and drying of an ink layer onto a suitable, preferably flexible and non-conductive, substrate, such as a polyester sheet. The ink is applied to the substrate in liquid form, preferably via a conventional printing process, such as flexographic, gravure or silk screen printing.

The ink in its liquid form preferably comprises a solvent carrier such as toluene, having electrically conductive particles suspended therein, optionally in the presence also of pigments, dispersing agents and/or other conventional ink additives. It is generally desirable that the solvent carrier should be able to be dried off by a hot air drier at a temperature in the range of between about 100 and about 220° C. in no more than about 15 seconds, to permit an efficient production process. The conductive particles may, for example, be micronised particles of metallic silver.

An example of a suitable ink is that marketed under the name Ink #E1400 by Ercon, Inc.

As mentioned above, an important feature of the present invention lies in the creation of a substantially void-free interface between the conductive layer of the current distribution member and the gel layer over substantially all of the area of passage of electrical current in the (or, in the case of a “split” electrode design, each) field of the current distribution member. The term “void-free” refers to the absence of nonconductive areas in the interface, in contrast to the prior art.

It has been found that the conductive inks of the types mentioned above can readily be laid down in liquid form to provide a substantially void-free coating on a support substrate by conventional printing techniques, which may advantageously be repeated more than once on the same support substrate to build up successive laminae, when forming a current distribution member, and either on original deposition or on subsequent drying, the ink forms very small globules which dry to leave an irregular surface topography (peak to trough heights typically up to about 4 pm) at the surface of the dried ink layer. Nevertheless, there is still a continuum of the deposited ink, which extends over substantially all of the area of passage of electrical current. The coating of liquid ink is suitably applied at such a coat weight (total of all applications where more than one) to yield a dry coat weight after drying in the range of about 0.5 to about 36 grams per square metre, more preferably about 5 to about 1 S grams per square metre.

Apart from the materials used in the current distribution member and the gel layer, the interface impedance of these layers can be greatly influenced by the surface topography of the current distribution member and hence of the interface between the current distribution member and the gel layer. The rougher the surface of the current distribution member, the smaller the interface impedance. In the case mentioned above, where a conductive ink is used to create the conductive layer of the current distribution member, a wide range of surface topography can be obtained by careful control of the liquid ink application step(s) and the drying step(s), optionally as well as by using a support substrate having itself an irregular surface topography. Moreover, by applying post-treatments such as etching to the deposited dry residue of the ink, further variability of the surface topography can be achieved, as will be well within the capability of one of ordinary skill in this art.

According to the concept of fractal geometry, a single parameter, the fractal dimension, D, is capable of characterising a rough surface without the need of a detailed description. Expressed simplistically, a perfectly smooth surface can be thought of as being 2-dimensional (D=2), whereas an extremely rough surface approximates to a 3 dimensional structure. Using the fractal concept, surfaces are found to have fractal dimensions such that 2<D<3. The rougher the surface of the conductive layer of the current distribution member in the electrode of the present invention, the larger the fractal dimension of the conductive layer will be, and the smaller the interface impedance between the conductive layer of the current distribution member will be.

In general, the surface topography of the current distribution member should have a fractal dimension in the range of about 2.3 to about 2.9, preferably between about 2.5 and about 2.8, as measured using a Burleigh SPM ARIS-3300 Atomic Force Microscope.

Electrode Cony Duration and Dimensions

The present invention is applicable to all configurations and dimensions of biomedical skin electrodes. The known electrode designs will be well known to those skilled in this art. One such design is illustrated as FIG. 1 of the accompanying drawings, and other designs are illustrated in the prior publications identified above.

For further details of the configurations and designs of electrodes in which the present invention may be used, attention is directed, for example, to the publications already referred to above, as well as general works of reference such as the Encyclopedia of Medical Devices and Instrumentation, Ed. John G Webster (particularly, for example, the discussion of electrosurgical electrodes in Volume 2).

Manufacturing Method

The electrode of the present invention may be manufactured by any appropriate method. Such methods will generally be readily apparent to those skilled in this art, either from common general knowledge or from the prior publications identified above.

Generally speaking, the electrode is manufactured in a building up process, in which the components are applied in any convenient order or sequence to the backing member. Multi-layer components, such as, for example, the preferred current distribution member, may conveniently be pre-assembled. The polymeric gel layer may conveniently be prepared in situ by polymerisation of a liquid or semi-liquid pregel layer deposited on the underlying component(s). If desired, bonding adhesives may be interposed between some or all of the components, in conventional manner.

The electrode is most preferably manufactured in an at least partially automated production-line process. The necessary equipment for this purpose will be generally known to one skilled in the art, or readily derivable therefrom. For further details of such equipment and machinery, attention is directed, for example, to the following publications: U.S. Pat. Nos. 4,715,382; 5,133,356; and 5,352,315; all the disclosures of which are incorporated herein by reference.

In on preferred manufacturing process, for the production of a multi-layer sheet electrode, the current distribution member is first assembled by deposition and drying of a conductive ink layer onto a non-conductive support sheet. A liquid pregel is then applied as a layer onto the conductive side of the current distribution member, leaving a small portion uncovered (which will form the electrical terminal arrangement). The pregel is then cured to form the polymeric gel layer in situ. The current distribution member is then cut to shape, forming also the gel-free tab which provides the electrical terminal arrangement. This shape is then applied, non-conductive side first, to an adhesive backing member sheet, and the exposed gel layer and the portion of the adhesive backing member sheet which has not been covered by the cut shape is protected by covering with a suitable release sheet. Finally, the overall electrode shape is cut from the backing member sheet, so as to leave a peripheral region of the backing member extending beyond the current distribution member.

For the deposition of the conductive ink onto the support sheet, a printing head preferably applies the ink in the desired coat weight to one major surface of the sheet material, there being relative movement between the sheet and the printing apparatus, i.e. the whole sheet is not coated simultaneously. A hot air drier then applies hot air to the liquid ink to rapidly dry it, again with relative movement between the sheet and the hot air drier. The ink application and drying cycle can be repeated as often as necessary.

### EXAMPLE OF THE INVENTION

The following non-limiting example is included as further illustration of the present invention.

The Example relates to a high performance circular electrode for use as a dispersive or return electrode in electrosurgery. The electrode is illustrated in FIG. 2 of the accompanying drawings, and has a conductive surface diameter of 10 cm, giving a conductive skin contact surface area of approximately 78.5 cm2. In FIG. 2, the reference numerals have the same meanings as in FIG. 1, discussed above, and their meanings will not be repeated here. However, it must be noted that, in the electrode of FIG. 2, the adhesive hydrogel layer 4 extends only over the area of the current distribution member 2, and a different adhesive 6 is provided as a coating on the periphery of the backing member 1 that extends beyond the current distribution member. The electrode as illustrated in FIG. 2 is significantly smaller than those conventionally used, yielding real benefits in terms of cost and convenience, while still conforming to ANSI/AAMI (American National Standards Institute/Association for the Advancement of Medical Instrumentation) standards.

Materials

The substrate used as a support for the dried ink layer in the current distribution member was 100 μm thick uncoated polyester (Stera Film PT100 Base), from Sterling Lohja Ltd. Etherow Works, Woolley Bridge, Glossop, Cheshire, SKIS 2NU, UK. Tel +44 1457 892300.

The silverink used was Ink #E1400 (4MPK/ITOL-68) silver ink, pre-thinned to 61.8% solids, manufactured by Ercon, Inc.7 Kendrick Road, Units 1-4, Wareham, Mass. 02571 USA. Tel 506 2911400.

The silver was printed using an Edale E250-S printer (manufactured by Edale Ltd. Budds Lane, Romsey, Hampshire SO51 OHA. Tel: +44 1794 524422).

Preparation of the Current Member

The silver ink is held in a reservoir, or pale, situated in close proximity to the printer. This pale is equipped with a propeller to continually agitate the mixture and avoid a silver sediment collecting at the base.

Two pipes lead from the pale. The first pipe is attached to a 505S peristaltic pump, supplied by Watson Marlow, Falmouth, Cornwall, England, set to 180 rpm. This pump leads to a “Vicosel” viscometer, manufactured by Brookfield Industrial Viscometers, Straughton, Mass. 02072, Tel. (614) 344 4310. The viscometer constantly monitors the viscosity of the ink in the pale and, should the viscosity increase above the ideal level of 62 psi, pumps solvent into the mixture to compensate for this. After passing through the viscometer, the ink flows back to the pale under the force of gravity.

The second pipe leading from the pale is the pipe that leads to the printer itself The ink is pumped from the pale using a 505S peristaltic pump, as above, but set to 100 rpm.

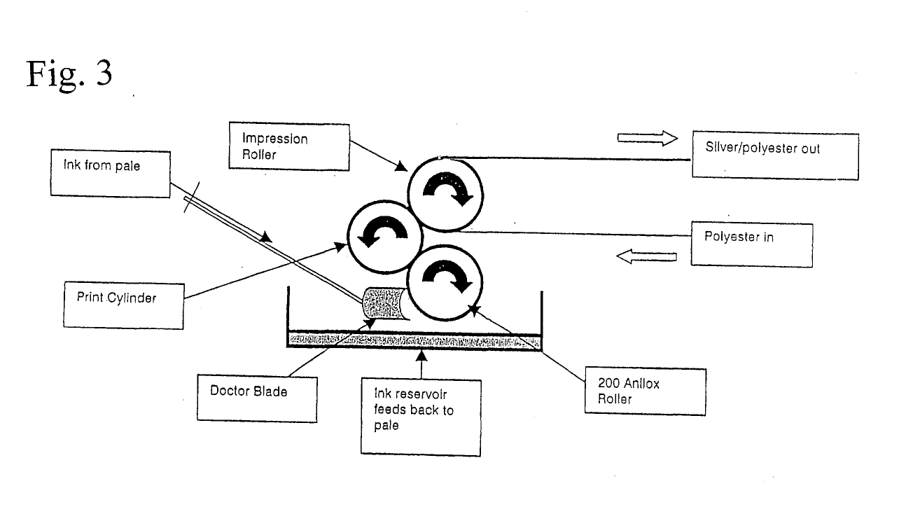

Referring now to FIG. 3 of the accompanying drawings, which shows schematically a printing apparatus for depositing the liquid ink onto the polyester support sheet to prepare the current distribution member, the ink is pumped into a doctor blade, which coats the ink evenly across a 200 Anilox roller. An Anilox roller is a print roller with many concave dimples, or “cells” within its surface. The benefit of this type of roller is that, by choice of the size and density of these cells on the roller, the quantity of ink picked up by the Anilox can be precisely controlled. As the Anilox turns, it coats the ink onto the print cylinder. Having been transferred to the print roller, the ink is printed onto the polyester sheet as it runs around the impression roller at 40 metres per minute.

The ink/polyester substrate is then (not shown) passed under a series of 5 heating elements which help the solvents within the ink to evaporate quickly. The heat from the heating elements is regulated so that the temperature on the surface of the web is kept in the region of 160 degrees centigrade. Having been thus dried, the substrate is then rolled up.

The above process was repeated once, so that the end product includes two coats of silver ink across one surface of the polyester sheet.

Application of the Conductive Adhesive Hydrogel Layer to the Current Distributio” Member

The material prepared above is then laminated (on the silver side) to a conductive adhesive hydrogel known as FW I OOAg, from First Water Ltd. Ramsbury, Marlborough, Wilts, SN8 2RB, UK. Tel. +44 1672 522133. The hydrogel is provided initially as a liquid pregel, which is coated onto the silver side of the current distribution member, and then cured to yield the polymerised hydrogel on the current distribution member.

Preparation of the Final Electrode Form

As broadly described above in the section headed “Manufacturing Method”, the resultant laminate from above is converted into completed electrodes on automated rotary die equipment, during which individual electrode body portions and integrated (gel free) tab connection elements are cut out from the laminate and sandwiched between a non-conductive foam backing layer having an adhesive coating on one face (this backing layer being located to the polyester side of the laminate) and a release liner (located to the hydrogel side). The resultant assembly is then cut out at a further die station (registered with the first) into the final product cut.

Analysis of the Electrode and Test Results

Electrode Impedance

The impedance of two electrodes connected gel to gel was measured using a Solartron SI 1260 Frequency Response Analyser (Solartron, Farnborough, Hants, UK) coupled to a 1286 Electrochemical Interface. The applied frequency was 500 kHz in order to harmonise with the ANSI/AAMI HF18-1993 standard for minimum safety and performance for electrosurgical systems (see below). The impedance was less than 3 ohms, i.e. for each electrode less than 1.5 ohms (the ANSI/AAMI HE compliance limit is 75 ohms per electrode). As it was purely resistive, it can be concluded that the capacitive impedance of the interface is negligible and that the measured resistance is due to the sum of the resistances of the two hydrogel layers, the two current distribution members and the resistances of connecting leads.

Current Distribution

Tests were carried out by Stuckenbrock GmbH, Germany on the current distribution under the electrode prepared as described above, using that company's GP Test II apparatus. The electrode under test is applied, gel down, to a plate comprising 180 small (1 cm2) sensors arranged in a grid (8×10). A constant alternating current voltage is applied across the test electrode and the sensing plate. The frequency of the applied voltage in this instance was 500 kHz in order to harmonise with the ANSI/AAMI HE 181993 standard for minimum safety and performance for electrosurgical systems (see below).

At each sensor in the grid the conductance (reciprocal of resistance) is calculated and is proportional to the local current flowing though the test electrode in the area above a given sensor (I=V/R=VG).

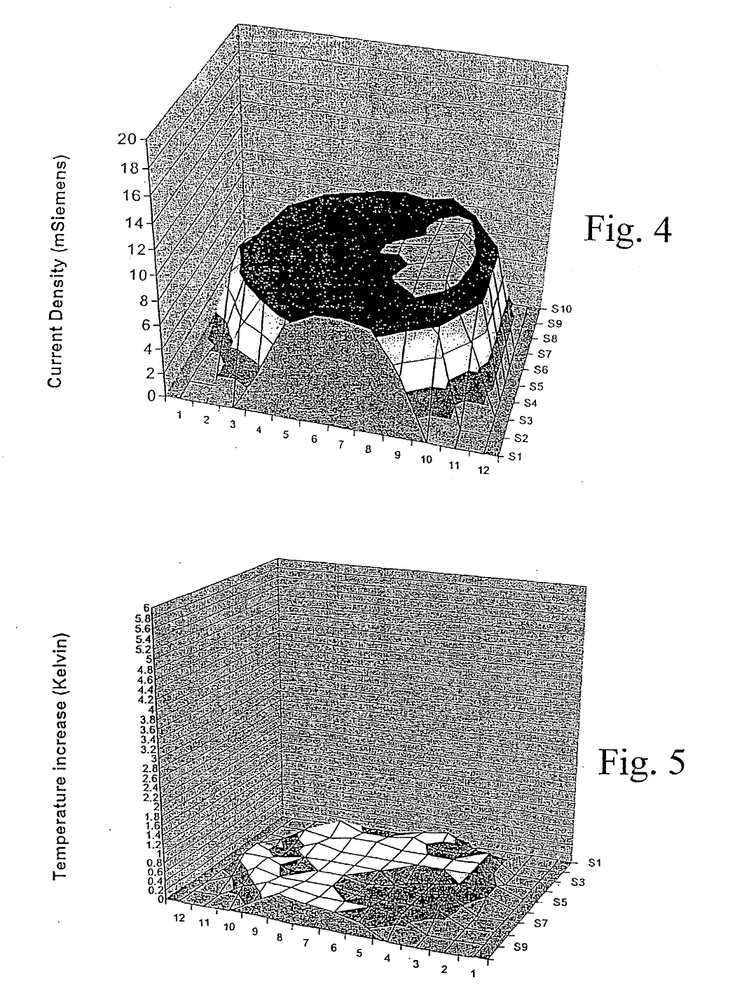

The obtained plot of the distribution of conductance (and hence local current) under the test electrode are shown in FIG. 4 of the accompanying drawings. It can be seen that the current distribution over the electrodes is relatively uniform, and that there is a marked absence of peripheral edge effects.

Temperature Rise

As current flows through an electrode and into the patient's skin it gives rise to an increase in temperature. If too much current flows through a small area of skin it can give rise to pain and tissue trauma. In electrosurgery, for example, the ANSI/AAMI HF18-1993 standard for minimum safety and performance for electrosurgical systems requires measurement of the distribution of temperature increases under an electrode and stipulates a maximum temperature rise of not more than 6° C. following the application of a current of 700 mA500 kHz for 60 sec.

The electrode prepared as described above was tested by Stuckenbrock GmbH, Germany and the results are shown in FIG. 5 of the accompanying drawings. It will be seen that the temperature rise is relatively uniform under the electrode, confirming the good distribution of the current. The maximum temperature rise was 0.6° C., well within the ANSUAAMI HF18-1993 standard.

Surface Analysis of the Silver-Coated Face of a f rst Current Distribution Member by Light Microscopy

A single area of the surface of a web of current distribution member material was selected for surface analysis, using the technique of light microscopy, under four different illumination/magnification combinations.

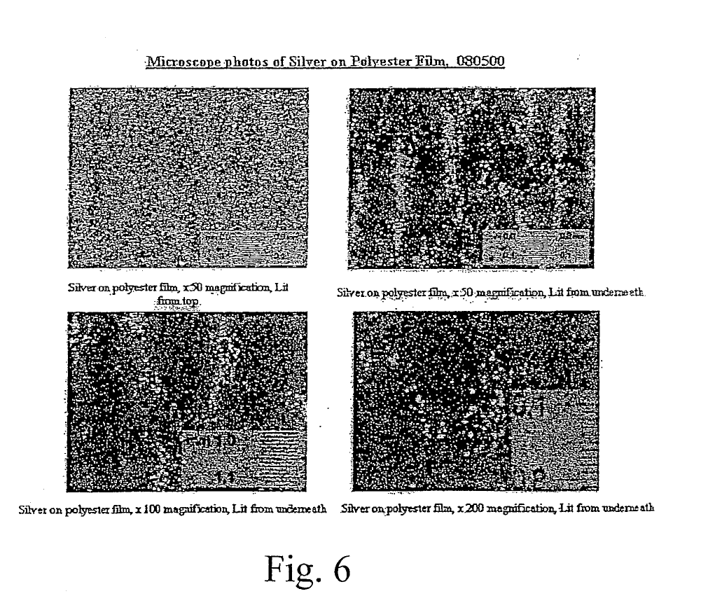

FIG. 6 of the accompanying drawings shows the resultant four photographs (a to d) taken on a Leica DMLM Industrial Microscope using Image Capture via a Leica DC 100 Digital Camera.

It is seen that the ink deposition and drying process has resulted in a conductive ink layer of the current distribution member which, although substantially void-free, has a non-uniform thickness that has a ‘grainy’ appearance when viewed under the microscope, and which is believed to play an important role in the observed reduction or elimination of peripheral hot spots or edge effects.

Surface Analysis of the Silver-Coated Face of a Second Current Distribution Member by Atomic Force Microscopy

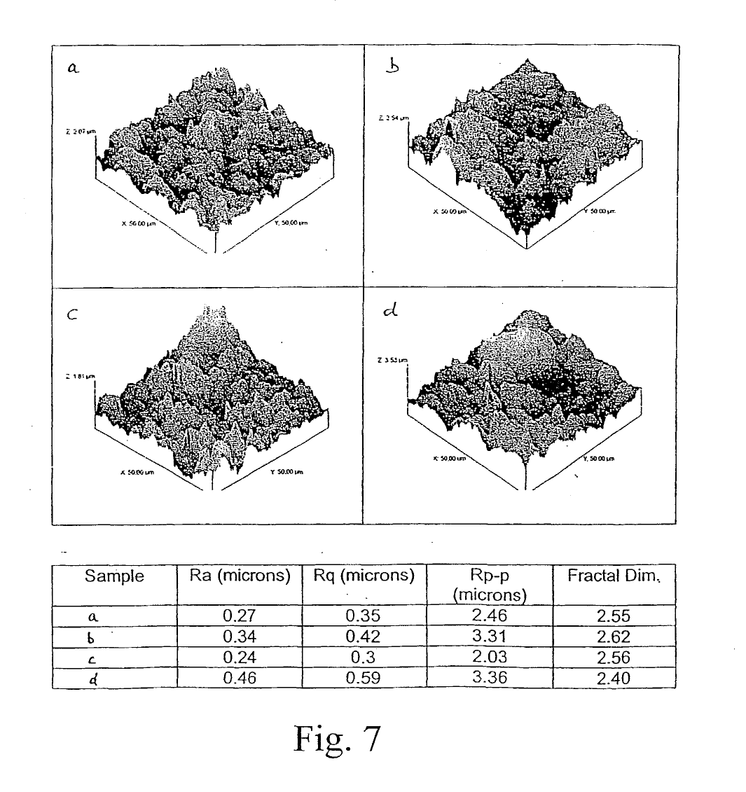

A Burleigh SPM ARIS-3300 Atomic Force Microscope was used to further investigate the deposited silver ink layer at four randomly selected areas of a second web of current distribution member material. The corresponding four Atomic Force Microscope images are shown in FIGS. 7a to d of the accompanying drawings. It was observed that each surface had a maximum peak to trough height in the range of 2 to 4 microns and a fractal dimension of approximately 2.5.

Sheet Resistance of the Conductive Layer of the Second Current Distribution Member

The sheet resistance of the dry ink residue layer of the second current distribution member material mentioned above was measured using a four-point probe (Fell Resistivity Equipment, Minirosin Ltd. England) coupled to a Thurlby current source and an RS Components 8010A Digital Multimeter and found to lie within the range of about 0.3 to about 0.5 ohms/□.

Industrial Applicability

The electrode of the present invention enables a marked reduction in high current density hot spots and edge effects generally, while providing for manufacturing by a simple process which is significantly cheaper than processes for making prior art electrodes having hot spot reducing features. One result of this is that biomedical electrodes can potentially be made smaller than hitherto, without loss of performance. The present invention thus makes a significant contribution to the art, by seeking to answer a need that hitherto has not been met.

The foregoing broadly describes the invention without limitation. Variations and modifications as will be readily apparent to those skilled in this art are intended to be covered by this application and subsequent patent(s).

The present invention further relates to biomedical electrostimulation electrodes, that is to say, surface electrodes for applying therapeutic electrical impulses to a patient.

In order to apply effective therapeutic electrical impulses to a patient, a suitable stimulator is connected electrically to at least one pair of electrodes attached to the patient's skin at locations judged by the therapist to be optimal for achieving the desired effect.

The distribution of current under the electrode is an important factor. In the simplest case, current density (the amount of current per unit of conduction area) is inversely proportional to the electrode/skin contact area. If the same current is applied through a pair of large electrodes and a pair of small electrodes, the stimulation effect will be most pronounced under the small area electrodes due to the increased current density. If a small electrode is used in conjunction with a large area electrode, the effect is more pronounced under the smaller of the two. In this case, the small electrode is often used as the “active” electrode to target a small area such as a motor point. The large electrode is simply used to complete the electrical circuit and is termed the “indifferent” or “dispersive” electrode.

Biomedical electrodes generally comprise a backing member (typically in sheet form), a layer of an electrically conductive hydrogel (or other electrically conductive adhesive) provided between the backing member and the patient's skin, and an electrical terminal arrangement in electrical contact with the hydrogel layer and adapted for connection to an electrical lead or apparatus. The electrode may, but need not, include a current distribution member in electrical contact between the hydrogel and the electrical terminal arrangement, which in use assists in distributing the electrical current to as wide an area of the hydrogel layer as possible.

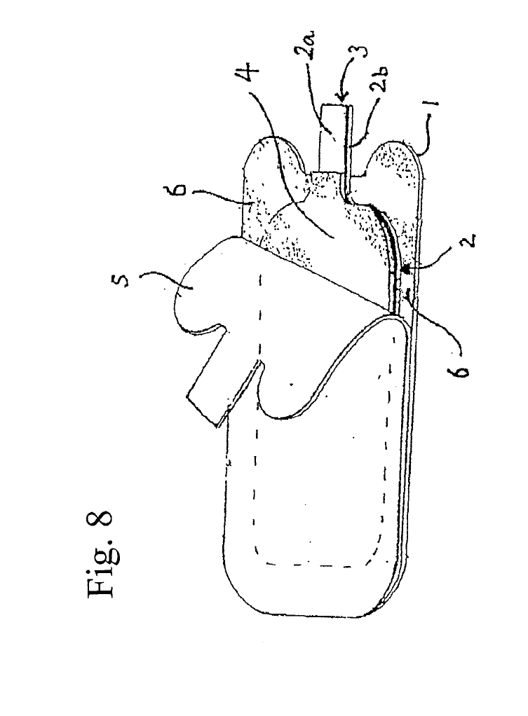

FIGS. 8 to 11 of the accompanying drawings shows one known design of biomedical electrode, marketed under the name NEUTRALECT (TM) (MSB Limited, Ramsbury, UK, tel +44 1672 522 100). This prior art electrode is used as an electrosurgical dispersive electrode, and is typically affixed to the patient's skin during electrosurgery to enable an electrical circuit to be completed through the patient's body. The electrode is quite large, over 15 cm in length. As shown in the figures, an electrically insulating backing member 1 in the form of a sheet of polyester foam has a current distribution member 2 stuck to it by a layer of nonconductive pressure-sensitive adhesive 6. The member 2 is a bilayer of an aluminium foil layer 2a on and coextensive with a non-foam polyester support layer 2b. The current distribution member 2 is of smaller dimensions than the adhesive-covered foam layer 1 such that latter extends beyond the periphery of the member 2 to provide secure adhesion of the electrode to the skin, even in the presence of fluids, and to reduce the risk of a member of the operating team accidentally touching the foil layer 2a when it is live. The purpose of the non-foam layer 2b is to support the relatively fragile foil layer 2a during manufacture. An electrical terminal comprises a tab formation 3 which is an integral lateral extension of the current distribution member 2 and is adapted to be gripped by electrically conductive jaws of a crocodile clip or the like (not shown) connected to a current supply lead.

The electrode also includes a layer 4 of an electrically conductive adhesive hydrogel layer, which in use adheres to the patient's skin and serves as an electrical connection between the patent and the foil layer 2a. With the exception of the terminal 3, which is not covered by the layer 4, the hydrogel layer 4 completely covers the foil layer 2a, sandwiching the foil layer 2a between it and the backing member 1. The hydrogel layer 4 is protected before use by a release layer 5 of siliconised paper or the like, which as shown is simply peeled off before use. Although electrically conductive, the hydrogel layer 4 has a substantially greater resistivity than the foil layer 2a.

Under a given electrode, it is generally highly desirable to have a uniform current density, since an increased concentration of the current at one or more points (“hot spots”) under the electrode may cause electrode deterioration or pain and trauma to the patient at otherwise safe overall current densities. At best in such cases, the applied current may have to be limited to less than therapeutic values due to the patient's discomfort.

With the highly conductive metal electrodes used for external cardiac pacing, defibrillation and electrosurgery, current density hot spots are often observed to occur under the perimeter of the electrode.

It has been shown (Wiley and Webster, “Analysis and Control of the Current Distribution under Circular Dispersive Electrodes”, IEEE Trans. Biomed. Eng., Vol. BME-29, pp. 381-385, 1982) that up to half of the total current flowing through a circular electrode can flow through an annular perimeter region having a width about 1/7th of the radius of the electrode. This is referred to in the literature as the fringe, edge or perimeter effect, and helps explain the observation that trauma due to current density hot spots often occurs on the skin underlying the peripheral edge of an electrostimulation electrode.

A simple intuitive picture will aid the understanding of this effect. When electrical current flows into a highly conductive metal electrode, for example the foil layer 2a of FIG. 8, it has the choice of continuing to flow through the conductive metal foil or into the more resistive hydrogel-skin interface. The electrical current chooses the path of least resistance and much of it continues to flow through the metal until it reaches the perimeter of the plate where it then is forced to flow through the gel into the patient.

Many suggestions have been made to reduce this edge effect observed with metal electrodes. These include:

(1) increasing the overall area of the electrode, thus decreasing the current density, or making the gel pad slightly larger than the electrode to enable the electric field lines to spread out before reaching the skin. Although this can solve the current density ‘hot spot’ problem, the use of large electrodes is not cost effective and is less than optimal when used on small patients, on small or curved parts of the body and in applications were the applied stimulus has to be targeted accurately. Using a gel pad much larger than the size of the electrode has less effect than would be expected as the perimeter of such a large gel pad will carry little current.

(2) increasing the overall resistance or thickness of the gel layer in order to give the current more “time” to spread out evenly through the gel. This can also be shown to be effective. The increased resistance will however lead to energy wastage and a thicker electrode structure would not be acceptable from an aesthetic or flexibility point of view. Manufacture would probably be problematic.

(3) increasing the resistance or thickness of the gel at the edges; For example, in IEEE Trans. Biomed. Eng., Vol. BME-33, pp. 845-853 (1986), Kim et al proposed an annular electrode in which the resistivity of the hydrogel layer varies as a function of radial distance from the centre, for use both in low-energy and also in high-energy applications such as electrosurgery and defibrillation. Although theoretically quite attractive, this solution is not practical from a manufacturing point of view.

(4) Depositing resistive layers on the outer edge of the electrode conductive plate, thus “forcing” more current to flow through the central portion of the electrode. U.S. Pat. No. 5,836,942 (Netherly et al, 1998) describes a power coupling electrode in which a generally annular field of “lossy dielectric” material is applied to the periphery of the current distribution member and the whole is overlain with the hydrogel layer. The arrangement is stated to reduce the extent of peripheral hot spots. Again, this solution is not without problems from a manufacturing point of view. Moreover, creating substrate areas of preferentially low impedance in the non-peripheral region of an electrode runs the risk of causing a high current density if the electrode becomes partially lifted or dislodged with current flowing, or if the electrode is not applied properly initially.

(5) Cutting the metallic plate so that the length of the perimeter is increased and hence the peripheral current density is decreased; the metallic plate generally has the form of a ‘flower’ with ‘petals’ extending towards the perimeter of the electrode. This solution is widely used in certain therapeutic applications by several companies. However it involves a relatively complex fabrication process and results in considerable wastage of the ‘stamped out’ portions of the conductive layer.

(6) U.S. Pat. No. 4,736,752 (Munck et al, 1988) describes a power coupling electrode in which a current distribution member formed by the deposition of a layer of a conductive ink on an insulating backing layer is provided with a regular and predetermined array of voids (non-conductive areas) arranged over its surface area. The arrangement is said to control the extent of peripheral hot spots. This solution suffers from similar problems to those of solution (5). Additionally, our tests indicate that the existing embodiments of this design are ineffective at significantly reducing current flow to the periphery of the conductive layer.

It is a object of the invention to provide an improved biomedical electrostimulation electrode in which the occurrence of hot spots may be reduced or eliminated.

Accordingly, the present invention provides a biomedical electrode comprising an electrically insulating backing member, a layer of conductive foil on the backing member, the foil layer comprising a terminal for attachment of a current supply lead, and a layer of an electrically conductive adhesive on the foil layer for fixing the electrode to a patient's skin and providing a current path from the foil layer to the patient's skin, the adhesive having a greater resistivity than the foil layer, wherein the foil layer has at least one aperture stamped therein.

Preferably the aperture has a concave edge proximal to the terminal.

The aperture may be a slit or a void in the foil layer.

The invention also provides a method of manufacturing a biomedical electrode comprising an electrically Insulating backing member, a layer of conductive foil on the backing member, and a layer of electrically conductive adhesive on the foil layer, the method comprising the step of stamping an aperture through the adhesive and into the conductive foil.

The term “foil” as used herein includes discrete foil layers as well as metallic printed layers provided on an electrically insulating backing member.

Embodiments of the invention will now be described, by way of example, with reference to the accompanying drawings, in which:

FIG. 8, previously described, is a perspective view of a biomedical electrostimulation electrode according to the prior art;

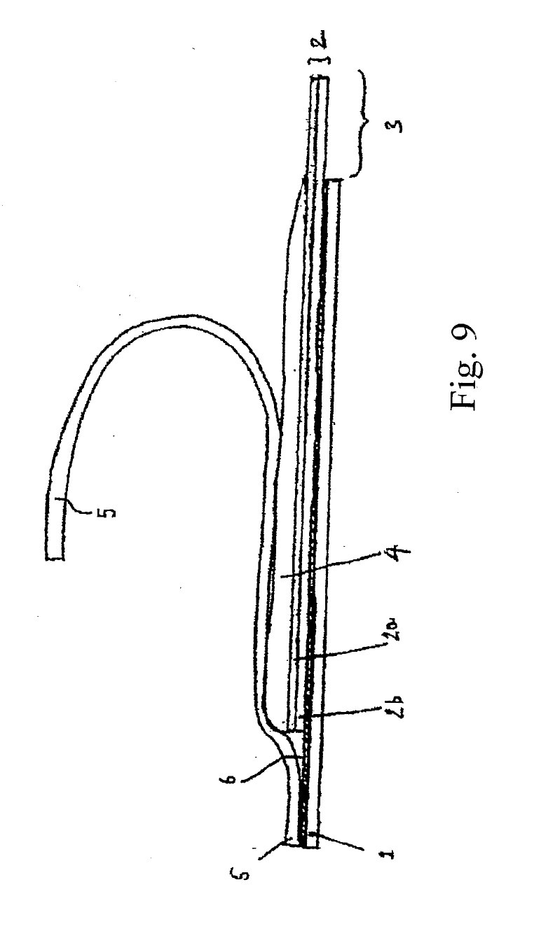

FIG. 9 is a cross-sectional view, not to scale, of the electrode of FIG. 8;

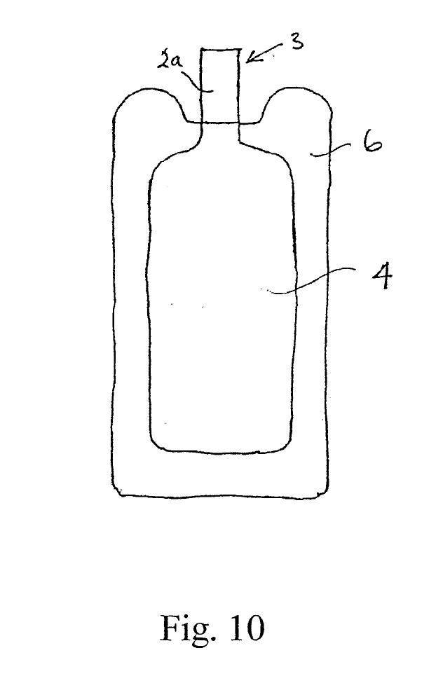

FIG. 10 is a top plan view of the electrode of FIG. 8, omitting the protective liner;

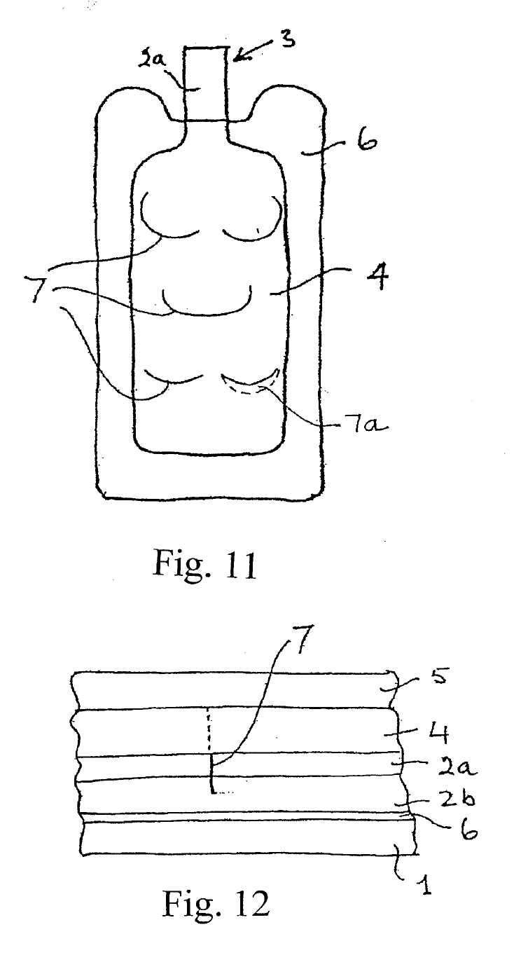

FIG. 11 is a top plan view, similar to that of FIG. 10, of a biomedical electrostimulation electrode according to an embodiment of the invention;

FIG. 12 is a detailed cross-section through the electrode of FIG. 11 in the vicinity of a slit 7;

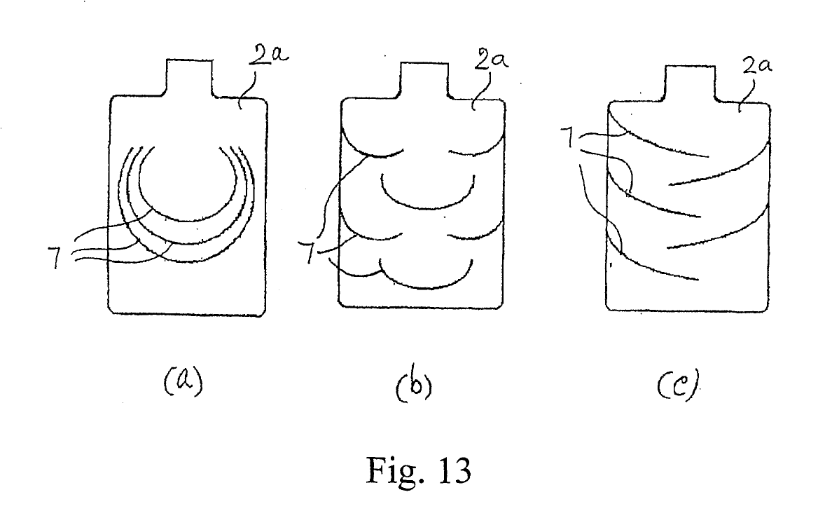

FIGS. 13(a) to 13(c) show various configurations of aluminium foil layers which can be substituted for that in FIG. 11 to provide further embodiments of the invention;

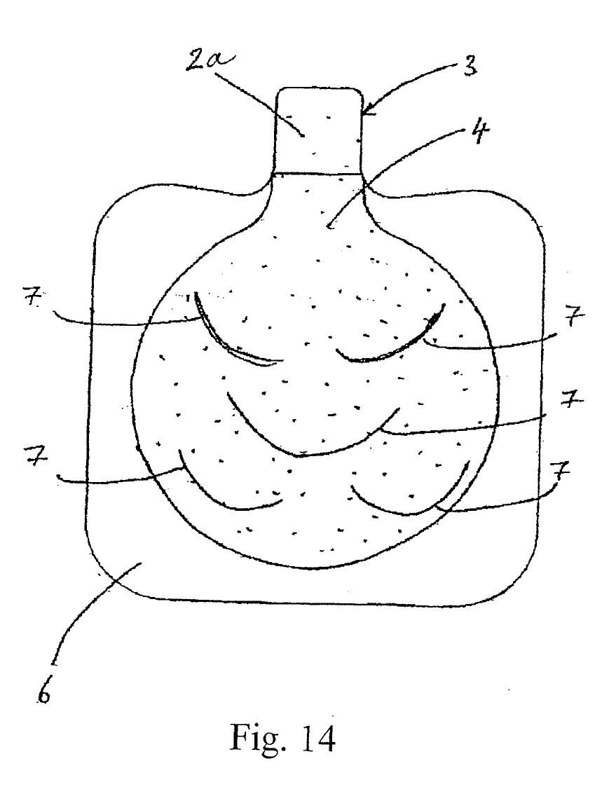

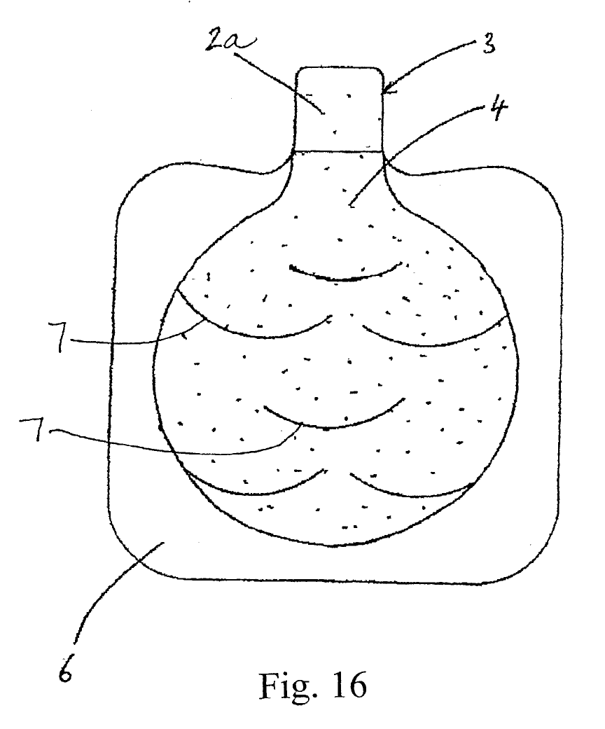

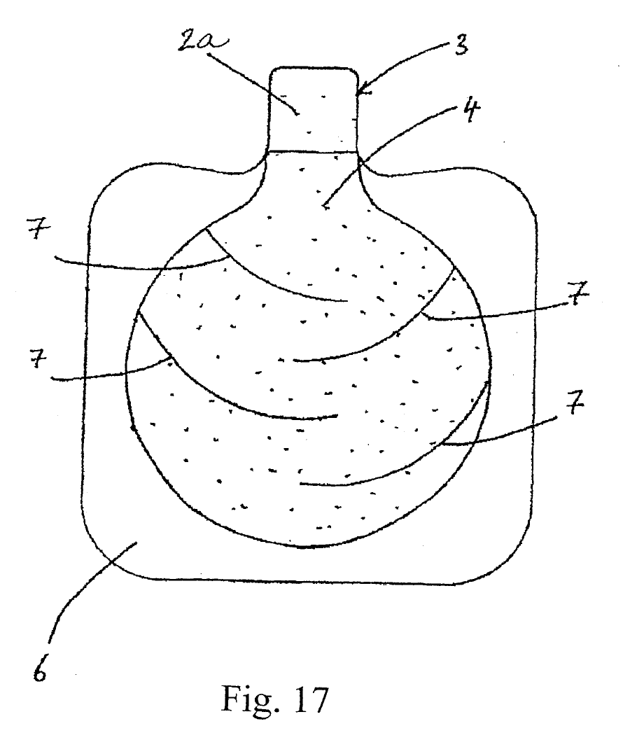

FIGS. 14 to 17 are a top plan views, similar to that of FIG. 10, of biomedical electrostimulation electrodes according to yet further embodiments of the invention; and

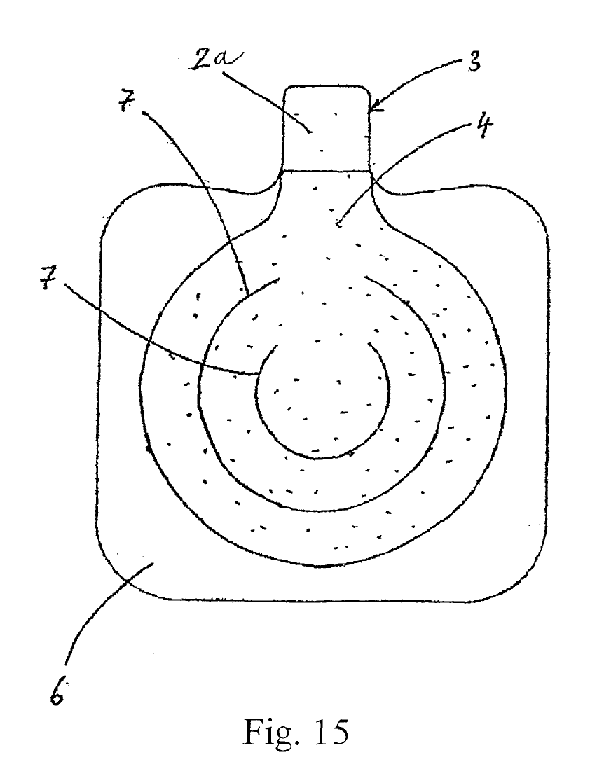

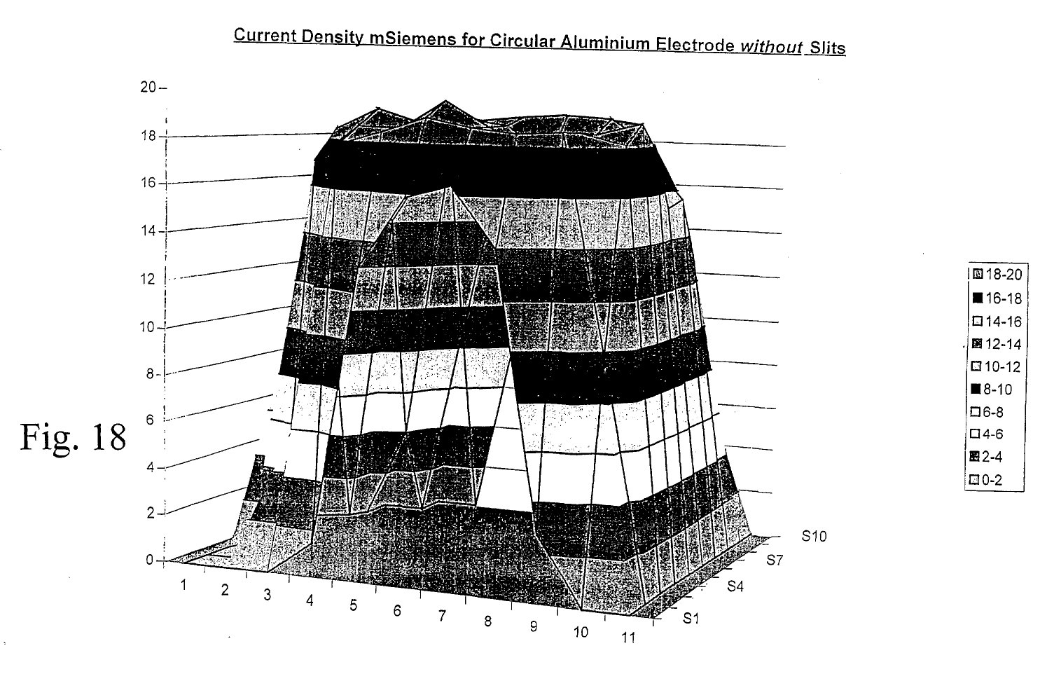

FIGS. 18 to 21 show the results of tests carried out on the electrode of FIG. 15.

Although computer modeling of the current distribution under biosignal electrodes has greatly improved over recent years, only the most simplistic electrode designs can be reasonably well modeled. Unfortunately, therefore, the design of suitable electrodes remains a tedious, empirical process.

The inventors therefore developed their own simple yet effective technique of directly observing the presence of current density ‘hot spots’. In their tests they used conductive silver layers formed by the deposition of silver coatings onto flexible substrates using a range of techniques including seriography. The layers were cut into various shapes, assembled as electrodes and large currents applied across the samples and an indifferent electrode which completed the circuit. As silver is changed into the relatively dark silverchloride upon the passage of current and in the presence of a chloride containing gel, the resultant current density distribution can readily be observed by inspection of the ‘photograph’ which forms on the conductive layer.

The inventors observed many of the anticipated effects of the shape of the conductive layer on the current density distribution. However, for conductive layers with cutout ‘voids’ the results were surprising. Circular voids appeared to have little effect in forcing current to enter the hydrogel layers at their “internal peripheral edges”, the current appeared to largely flow around such voids and continue to the outer edges of the conductive layer.

However, concave slits facing generally towards the current supply terminal were observed to have a marked effect on current density distribution, with the concave proximal edges of the slits effectively blocking the lateral flow of current, forcing the ‘trapped’ current to flow into the hydrogel and thus achieving a more uniform current density distribution over the surface of the conductive layer.

Furthermore, since no material is removed when simple slits are made, the surface area of the electrode is maintained at a maximum.

An embodiment of the invention which incorporates such concave slits is shown in FIG. 11. This embodiment is essentially the same as the known embodiment of FIGS. 8 to 10, with the addition of a 2-dimensional array of concave slits 7 formed in the aluminium foil layer 2a. Each slit 7 has its concave edge proximal to the terminal 3.

The provision of multiple slits 7 at different distances from the terminal 3 enhances the effect referred to above, in that the slits 7 further away from the terminal 3 appear to ‘capture’ current which manages to ‘slip between’ the more proximal slits, much like the capture of metal balls by concave barriers in bagatelle.

The slits 7 in the foil layer 2a are formed by stamping the electrode with a suitably shaped cutting die during manufacture, after the deposition of the hydrogel layer 4 but before the application of the release layer 5. As shown in FIG. 12, this means that the gel layer 4 will be cut along with the layer 2a, but this cut will “heal” by gradual flowing together of the gel on either side of the cut (this is indicated by the dashed lines in FIG. 12). The die will also need to penetrate partially into the non-foam layer 2b to ensure complete separation of the opposite sides of the slits 7 in the foil layer 2a.

The slits could alternatively be stamped through the backing layer and into the conductive layer, or the foil could be stamped before the layers are assembled, but it has been found that the most advantageous method of creating the slits is to stamp through an adhesive layer which subsequently heals over.

Some alternative slit layouts are shown in FIGS. 13(a) to 13(c). It will be noted that the above effect is further enhanced in FIGS. 13(b) and 13(c) by at least some of the slits 7 extending right to the peripheral edge of the foil layer 2a. Further embodiments of the invention which use a circular foil layer 2a, but which may in other respects be the same as the electrode of FIG. 8, are shown in FIGS. 14 to 17. In all cases the slits 7 have their concave edges proximal to the terminal 3 and are stamped into the foil layer 2a in the manner described with reference to FIG. 12.

Since the “active” edge of each slit 7 is predominantly the proximal concave edge facing the terminal 3, it is possible, instead of or as well as concave slits 7, to provide voids in the foil layer 2a to serve the same purpose. Such voids will have edges which are concave proximal to the terminal 3. An example of a void which may be used instead of a slit is shown in dashed lines at 7a in FIG. 11. Such voids 7a are also stamped out by a cutting die, but this occurs earlier in the manufacturing process, before the member 2 is attached to the insulating backing layer 1.

It is to be understood that the term “concave” as used herein includes any generally tray or trough-like aspect and does not require the proximal edges of the slit or void to be continuously curved.

Experimental Results

1. Current distribution

Tests were carried out by Stuckenbrock GmbH, Germany on the current distribution under electrodes of the form shown in FIG. 15, using their GP Test II apparatus. The electrode under test was applied, gel down, to a plate comprising 180 small (1 cm2) sensors arranged in a grid (8×10). A constant ac voltage was applied across the test electrode and the sensing plate. The frequency of the applied voltage in this instance was 500 kHz in order to harmonise with the ANSI/AAMI HF18-1993 standard for minimum safety and performance for electrosurgical systems (see below). At each sensor in the grid the conductance (reciprocal of resistance) was calculated and was proportional to the local current flowing though the test electrode in the area above a given sensor (I=V/R=VG).

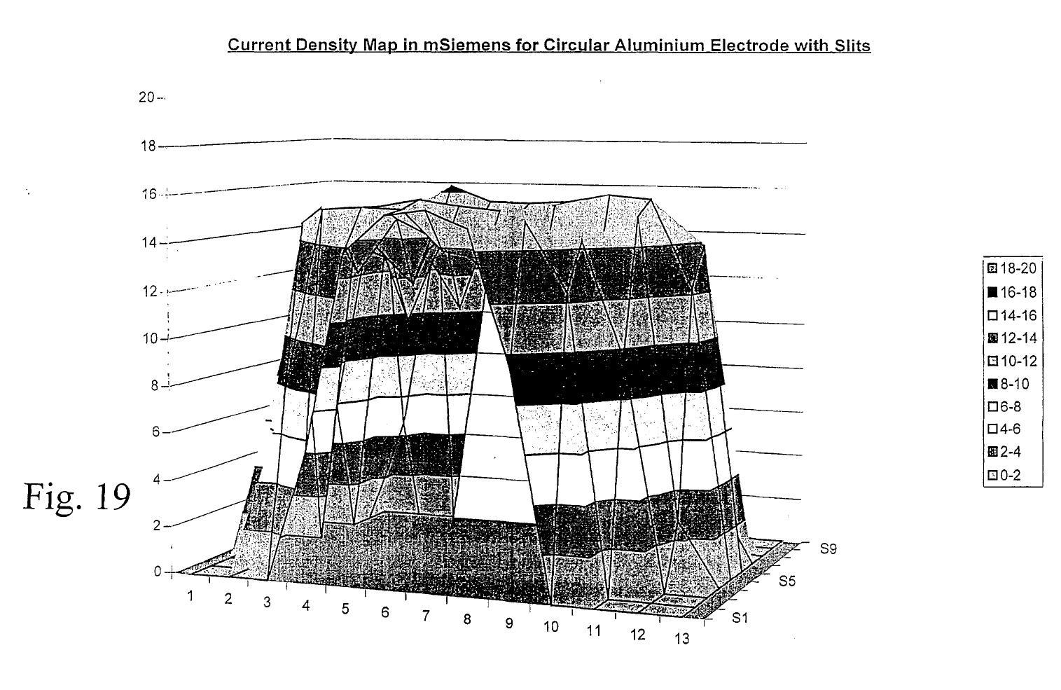

A plot of the distribution of conductance (and hence local current) under the test electrodes are shown in FIGS. 18 and 19. It can be seen that the current densities under the aluminium electrode with slits (FIG. 19) is significantly less than that under the same electrode without slits (FIG. 18).

2. Temperature Rise

As current flows through an electrode and into the patient's skin it gives rise to an increase in temperature. If too much current flows through a small area of skin it can give rise to pain and tissue trauma. In electrosurgery, for example, the ANSI/AAMI HF18-1993 standard for minimum safety and performance for electrosurgical systems requires measurement of the distribution of temperature increases under an electrode and stipulates a maximum temperature rise of not more than 6° C. following the application of a current of 700 mA 500 kHz for 60 sec.

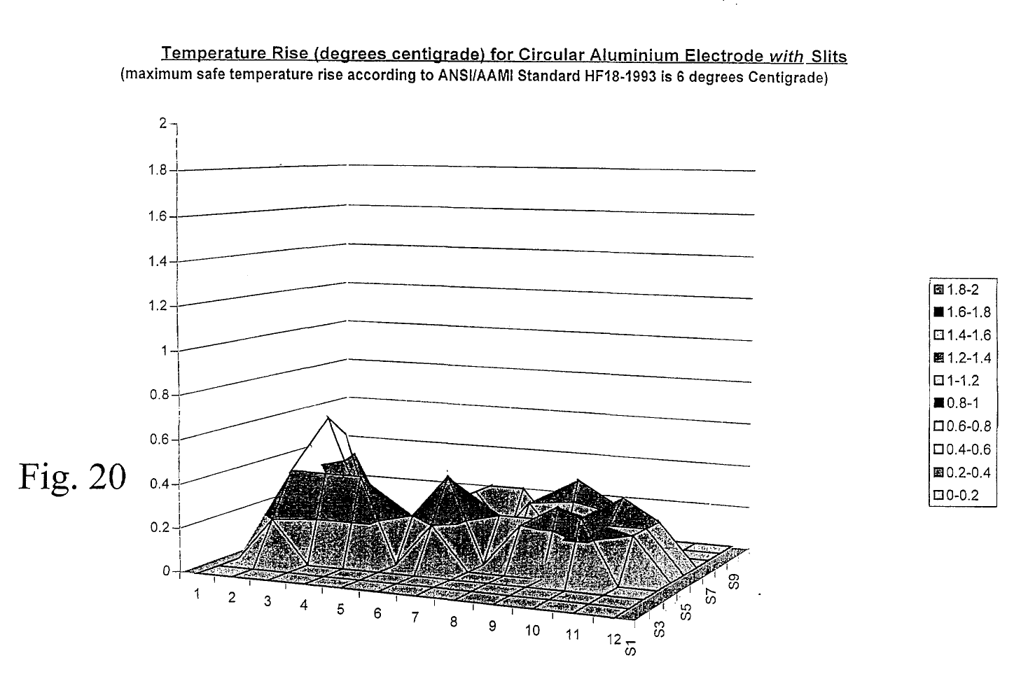

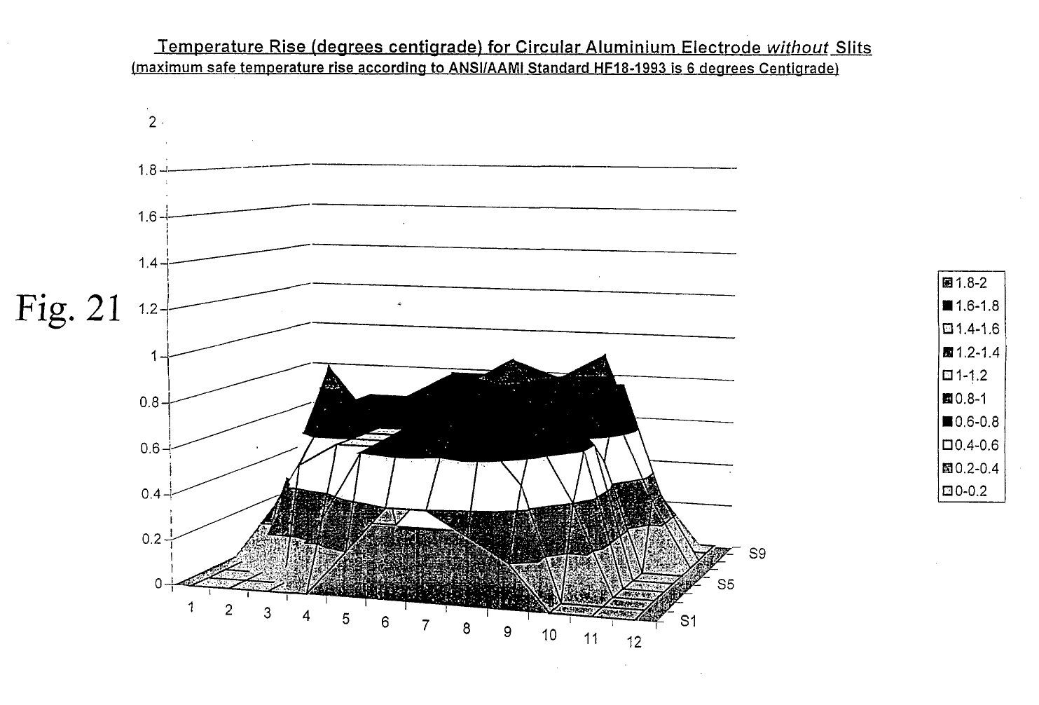

The embodiment of the invention as described above was tested by Stuckenbrock GmbH, Germany and the results in FIGS. 20 and 21 were observed. The figures show temperature increase across the surface of the electrode against a scale proportionate to the 6° C. Maximum allowed by the ANSI/AAMI HF18-1993 Standard. The temperature rise under the electrode with slits (FIG. 21) is relatively uniform (indicating good distribution of the current) and is significantly less than under the electrode without slits (FIG. 20). The maximum temperature rise was 0.6° C., well within the ANSI/AAMI HF18-1993 standard.

The invention is not limited to the embodiments described herein which may be modified or varied without departing from the scope of the invention.

1. A biomedical electrode structure adapted to contact in use an area of a patient's skin to conduct electrical current thereto or therefrom, the electrode comprising:
(i) a backing member;
(ii) an electrically conductive gel layer for contacting the patient's skin;
(iii) an electrical terminal arrangement adapted for connection to an electrical lead or apparatus; and
(iv) a current distribution member, comprising a relatively thin, electrically conductive layer, the current distribution member contacting the gel layer (ii) via an interface between the conductive layer of the current distribution member and the gel layer (ii) and providing an electrical connection between the gel layer (ii) and the electrical terminal arrangement (iii), the conductive layer of the current distribution member having an electrical sheet resistance and the interface between the between conductive layer of the current distribution member and the gel layer having an electrical impedance;
wherein the electrical resistance of the conductive layer of the current distribution member (iv) and the electrical impedance of the interface between the conductive layer of the current distribution member and the gel layer are selected to substantially avoid the occurrence of undesirable peripheral hot spots or edge effects when the electrode is in use.

2. An electrode structure as in claim 1 wherein the current distribution member (iv) consists essentially of a conductive layer, which may, for example, comprise a conductive sheet or foil, e.g. of metal or of a composite including conductive particles embedded in a conductive matrix

3. An electrode structure as in claim 1 wherein the current distribution member (iv) comprises the dry residue of an electrically conductive ink. For example, by printing conductive silver ink using a flexographic technique onto a suitable substrate such as polyester.

4. An electrode structure as in claim 1 wherein the sheet resistance of the current distribution member (iv) will suitably be in the range of about 0.01 to about 50 ohms/□, more preferably about 0.1 to about 0.5 ohms/□.

5. An electrode structure as in claim 1 wherein the electrical impedance of the interface between parts (ii) and (iv) is preferably maintained as low as possible.

6. An electrode structure as in claim 1 wherein the current distribution member is substantially void-free but has a microscopically rough surface to ensure that the impedance of the interface between the conductive layer of the current distribution member and the gel layer is as low as possible.

7. An electrode structure as in claim 1 wherein the current distribution member is substantially void-free but has an irregular interface between the current distribution member and the gel layer, the surface topography of the current distribution member having a fractal dimension in the range of about 2.3 to about 2.9, preferably between about 2.5 and about 2.8

8. An electrode structure as in claims 1 and 3 wherein the current distribution member is fabricated by coating a conductive ink onto a support substrate by conventional printing techniques in such a way as to form small globules which dry to leave a substantially void-free but irregular interface with peak to trough heights typically up to about 4 μm

9. An electrode structure as in claims 1 and 3 wherein the current distribution member is a void-free coating of conductive ink deposited onto a support substrate by conventional printing techniques, which may advantageously be repeated more than once on the same support substrate to build up successive laminae in such a way as to leave a substantially but irregular interface with peak to trough heights typically up to about 4 μm.

10. An electrode structure as in claims 1 and 3 wherein the coating of liquid ink is suitably applied at such a coat weight (total of all applications where more than one is used) to yield a dry coat weight after drying in the range of about 0.5 to about 36 grams per square metre, more preferably about 5 to 15 grams per square metre

11. An electrode structure as in claim 1 wherein the backing member (i) has an irregular surface topography mirroring the desired configuration of the interface between layers (ii) and (iv).

12. A biomedical electrode structure adapted to contact in use an area of a patient's skin to conduct electrical current thereto or therefrom, the electrode comprising:
(i) a backing member;
(ii) an electrically conductive gel layer for contacting the patient's skin;
(iii) an electrical terminal arrangement adapted for connection to an electrical lead or apparatus; and
(iv) a current distribution member, comprising a relatively thin, electrically conductive layer, the current distribution member contacting the gel layer (ii) via an interface between the conductive layer of the current distribution member and the gel layer (ii) and providing an electrical connection between the gel layer (ii) and the electrical terminal arrangement (iii), the conductive layer of the current distribution member having at least one aperture stamped therein to substantially hinder current flow from the terminal to the to the peripheral edges of the distribution member.

13. An electrode structure as in claim 12 wherein the aperture(s) has/have a concave edge proximal to the terminal to substantially hinder current flow from the terminal to the to the peripheral edges of the distribution member.

14. An electrode structure as in claims 12 and 13 wherein the aperture(s) is/are a slit in the distribution member.

15. An electrode structure as in claims 12 and 13 wherein the aperture(s) is/are a void in the distribution member.

16. An electrode structure as in claim 15 wherein the void(s) in the foil layer is/are essentially crescent shaped [or at least have (a) concave proximal edge(s), claim 2].

17. An electrode structure as in claim 12 wherein 2-dimensional arrays of concave slits or voids are so arranged (much like the concave barriers in bagatelle) to substantially hinder current flow from the terminal to the to the peripheral edges of the distribution member.

18. An electrode structure as in claim 17 wherein the concave slits of the 2-dimensional array may extend to the lateral/peripheral edges of the distribution member to effectively create further concave “internal peripheral edges” and thus further hinder current flow from the terminal to the to the peripheral edges of the distribution member of or voids [see FIGS. 6b & c].

19. An electrode structure as in claim 12 wherein arrays of concave slits or voids are so arranged as to be almost ‘concentric’.
